(19) United States
(12) Patent Application Publication
(10) Pub. No.: US 2011/0025070 A1
(43) Pub. Date: Feb. 3, 2011

(54) Utility grid vertical axis wind turbine system

(76) Inventor: Arnold Price, Loveland, CO (US)

Correspondence Address: ARNOLD E. PRICE, 3274 SEDGWICK CIRCLE, LOVELAND, CO, 80538, US

(21) Appl. No.: 12/658,744

(22) Filed: Feb. 16, 2010

Related U.S. Application Data
(63) Continuation-in-part of application No. 12/584,984, filed on Sep. 16, 2009.

(30) Foreign Application Priority Data
Jul. 31, 2009 (US) PCT/US2009/004413

(51) Int. Cl. F03D 3/00

(52) U.S. Cl. 290/55

(57) ABSTRACT

A vertical axis wind system for distributed wind energy generation to a utility grid has an overhead electricity structural support member for supporting an electricity conductor connected to the utility grid. The structural support member has at least one rotor shaft portion with an outer surface and a vertical axis of rotation. At least one vertical axis wind turbine having a rotor assembly, including a plurality of wind vanes, is erected on the rotor shaft portion so that the rotor assembly rotates freely around the outer surface of the rotor shaft portion when exposed to an atmospheric wind condition. A power takeoff assembly is coupled to the wind turbine using a drive member and a driven member. A generator is driven by the driven member, and a transmission line is connected to the generator for electrification of the utility grid.

### CROSS REFERENCE TO RELATED APPLICATIONS

This application is a continuation-in-part of application Ser. No. 12/584,984, filed 16 Sep. 2009, which claims the right to priority of International Application Ser. No. PCT/US2009/004413, filed 31 Jul. 2009.

### STATEMENT OF FEDERALLY SPONSORED RESEARCH

Not applicable.

### BACKGROUND OF THE INVENTION

1. Field of the Invention

The present invention relates to distributed wind energy generation. In particular, it relates to a vertical axis wind turbine system deployed on the power grid for converting energy extracted from atmospheric wind into electrical energy transmitted to the power grid.

2. Description of the Related Art

Vertical axis wind turbines are well known in the art for extracting energy from atmospheric wind, and converting that energy, into electrical energy. Wind power turbines have been shown to be capable of generating power for delivery, via interconnection, to existing grid systems, individual homes, businesses, or utilities. Most of all of the wind power systems are designed to gather large amounts of power, in the Mega Watt range, through the deployment of enormous wind turbines, which are typically at least 100 feet high. Small wind powered turbines have also been deployed, and are configured to power a single home, business, or certain elements of a home or business.

In large wind installations, in the magnitude of 100 foot or more, giant sized turbines often dot the landscape and compromise the environment. Such large turbines are typically deployed in remote areas, far away from the public infrastructure, and require massive construction projects for their interconnection back to the existing grid. As a result, these installations are deployed far from the utility grid making which makes access of wind energy to homes or businesses very difficult. Finally, with a large wind turbine system an enormous investment is required. However, such investments have recently been viewed as a poor investment because they will simply not generate enough power when exposed to the constant changes in atmospheric wind conditions.

In contrast, small wind power systems are typically deployed in isolated areas. Such isolated deployments are therefore not useful in carrying out the direct powering of homes and business over large areas of land, or in establishing connection points to the utility grid.

In order to overcome the foregoing problems associated with the deployment of large and small wind turbine systems, others have contemplated deployment in existing locations, which maybe connected to supplement power to an existing power grid. One such example, disclosed in U.S. Pat. No. 7,525,210, to Fein et. al., is described for a roadway system of creating a networked infrastructure distribution platform of fixed wind gathering devices. There, the roadway system includes ground based wind energy turbines in combination with one or more roads and the roadway system electricity grid. The roadway system contemplates the conversion of wind conditions either generated by passing motor vehicles and the atmosphere. The turbines are connected to the roadway system electricity grid, and are positioned along the roads to in order to take advantage of the wind turbulence generated from the passing motor vehicles.

While the foregoing example offers some utility, a major disadvantage with this application lies in the fact that, while it does provide for additional beneficial use of the existing roadway electrical grid, it continues in the past practice of requiring the construction of a network of wind turbine machines, together with all of their associated ground based supporting structures, and points of connection for installation along predetermined positions of the roadway. Therefore, such installations must be optimally engineered in turbine design, structure height, and investment potential in order to provide for the efficient use of wind energy from passing motor vehicles and atmospheric wind. Moreover, one must still analyze, as an overall component of the system, the overall environmental impacts associated with its construction, operation, aesthetic appeal, and safety. Thus, it is desirable to provide a distributed wind power energy system which is capable of ground-based deployment on the existing power grid infrastructure, but which also takes advantage of investment potential, is simple in design, installation, and use, and which does not expand the existing environmental foot print. It is also desirable to provide a distributed wind energy system which is directly connected to the power grid infrastructure which is useful in the generation of electricity to both large and small energy utilities, homes and businesses. The present invention satisfies these needs.

### BRIEF SUMMARY OF THE INVENTION

It is therefore an object of the present invention to provide a distributed wind power energy system capable of converting wind energy for transmission directly to the power grid.

It is another object of the present invention to provide a distributed wind power energy system which deploys on an existing ground-based electricity grid installation.

It is another object of the present invention to provide a distributed wind power energy system which is attractive in investment potential, simple in design, deployment, use and construction, but which does not expand the existing environmental foot-print.

It is another object of the present invention to provide a distributed wind power energy system which is capable retrofit deployment on existing utility grid supporting structures.

It is yet another object of the present invention to provide an integrated large or small wind power infrastructure that is easily connected to multiple direct sources or various grid interconnection points.

To overcome the problems associated with the prior art methods, and in accordance with the purpose of the present invention, as embodied and broadly described herein, briefly a vertical axis wind system for distributed wind energy generation to a utility grid has an overhead electricity structural support member for supporting an electricity conductor connected to the utility grid. The structural support member has at least one rotor shaft portion with an outer surface and a vertical axis of rotation. At least one vertical axis wind turbine having a rotor assembly, including a plurality of wind vanes, is erected on the rotor shaft portion so that the rotor assembly rotates freely around the outer surface of the rotor shaft portion when exposed to an atmospheric wind condition. A power takeoff assembly is coupled to the wind turbine using a drive member and a driven member. A generator is driven by the driven member, and a transmission line is connected to the generator for electrification of the utility grid.

Additional advantages of the present invention will be set forth in part in the description that follows and in part will be obvious from that description or can be learned from practice of the invention. The advantages of the invention can be realized and obtained by the apparatus particularly pointed out in the appended claims.

### BRIEF DESCRIPTION OF THE SEVERAL VIEWS OF THE DRAWINGS

The accompanying drawings, which are incorporated in and which constitute a part of the specification, illustrate at least one embodiment of the present invention, and, together with the description, explain the principles of the invention.

FIG. 1 shows is a perspective view of the present invention deployed in combination with a power pole.

FIG. 2 is a cross-sectional view of the present invention deployed on the power pole, as shown in FIG. 1.

FIG. 3 is a perspective view of the present invention showing deployment of a wind turbine array together with the associated generators on a plurality of power poles.

FIG. 4 is a perspective view of the present invention showing deployment of the wind turbine in a two generator configuration and as deployed on a digital signal tower.

FIG. 5 is a cross sectional view of a preferred embodiment, shown in FIG. 4, showing the power takeoff having the drive gear driving two driven gears and generators with the generators deployed in lateral alignment to the structural support members.

FIG. 6 is a perspective view of another example of the present invention showing two structural support members attached to lateral cross bars erected on the power pole for erecting two vertical axis turbine assemblies, and where the generators are in axial alignment with the rotor shaft portions.

FIG. 7 is a perspective view of the present invention showing deployment of a wind turbine array, as configured in FIG. 6.

FIG. 8 is a perspective view of an embodiment of the present invention where the ground based power pole is a utility tower having two rotor shaft portions.

FIG. 9 is a perspective view of the present invention showing an embodiment where the wind turbine is positioned on top of a tower in axial alignment with the power take off assembly constructed below ground level.

FIG. 10 is a perspective view showing an array of the wind turbine towers as shown in FIG. 9.

FIG. 11 is a side view of an embodiment of a 230 kV double circuit system with six vertical axis turbines on top of the tower each with six cross bars supporting six rotor shaft portions for erecting six wind turbine rotor assemblies each having a generator positioned in axial alignment with the rotor shaft portions.

FIG. 12 is an array of five towers having the vertical axis wind turbine embodiment as shown in FIG. 11.

FIG. 13 is a side view of an embodiment of the vertical axis wind system showing a 115 kV double circuit power pole system with two vertical axis turbines erected on top of the power pole where the generators are in axial alignment with the rotor shaft portions.

FIG. 14 is an array of five power poles having the vertical axis wind turbine embodiment as shown in FIG. 13.

FIG. 15 is a perspective view of the vertical axis wind system erected on top of a digital transmission pole with two generators positioned in lateral alignment to the rotor shaft portion of the pole.

### DETAILED DESCRIPTION OF THE INVENTION

Unless specifically defined otherwise, all technical or scientific terms used herein have the same meaning as commonly understood by one of ordinary skill in the art to which this invention belongs.

A “wind turbine array” means a plurality of wind energy generating devices either on a network of power poles, or on a single power pole.

An “electricity system” means a ground based network of electrical connections for the transportation and transmission of electrical energy, and may, but need not, include, energy storage systems, controls for inverting energy, power source changing units, electricity meters, and backup power systems.

The “utility grid” or “grid” means, the existing infrastructure of electrical lines and power boxes, as further described below.

An “energy storage system” as used herein is any device that can store electrical energy including, without limitation, systems which transform electrical energy into some other form of energy such as chemical or thermal.

The term “structural support member” means any upright supporting member for an overhead electrical conductor such as power poles, pylons, transmission towers, telephone poles, digital signal transmission towers, large scale electrical transmission towers, and signs.

Although any of the methods and materials similar or equivalent to those described herein can be used in the practice or deployment of the present invention, the preferred methods and materials are now described. Reference will now be made in detail to the presently preferred embodiments of the invention, examples of which are illustrated in the accompanying drawings wherein like numerals represent like features of the invention.

The invention provides a vertical axis wind system 10 for distributed wind energy generation of electrical energy to a utility grid. The system 10 is particularly useful in that it is particularly suitable for use in retrofit deployment on an existing power pole 12 or transmission tower 120 support members of an electricity infrastructure connected to the utility grid.

The utility grid is a power transmission network. The power grid is the bulk transfer of electric power to consumers. Multiple redundant lines between points on the network are connected so that power can be routed from any power plant to any load center. Transmission companies determine the maximum reliable capacity of each line, which, due to system stability considerations, may be less than the physical or thermal limit of the line. Thus, the d-c potential produced by the generator 24, in accordance with the present invention, is easily matched with the transmission companies' requirements and may be transmitted in a monopole or bipolar configuration.

A system which typically connects power plants to multiple substations near a populated area is called an electricity transmission system. The wiring from substations to customers is referred to as an electricity distribution utility grid or system. This system follows the well known business model separating the wholesale electricity transmission business from distributors which deliver the electricity to the homes. The utility grid allows distant energy sources (such as power plants) to be connected to consumers in population centers. Usually the transmission lines use alternating current or, as in the case of high voltage systems, direct current which is used for long distance transmission or undersea applications and in connecting different alternating current networks. The power is usually transmitted as alternating current through overhead power lines 15 supported on power poles or towers. Such systems are typically either of a monopole or, as shown in the drawing figures, of a bipolar construction where one conductor 18 is positioned on each side of the cross bars 17, at a span distance dependant on the length of the cross bar.

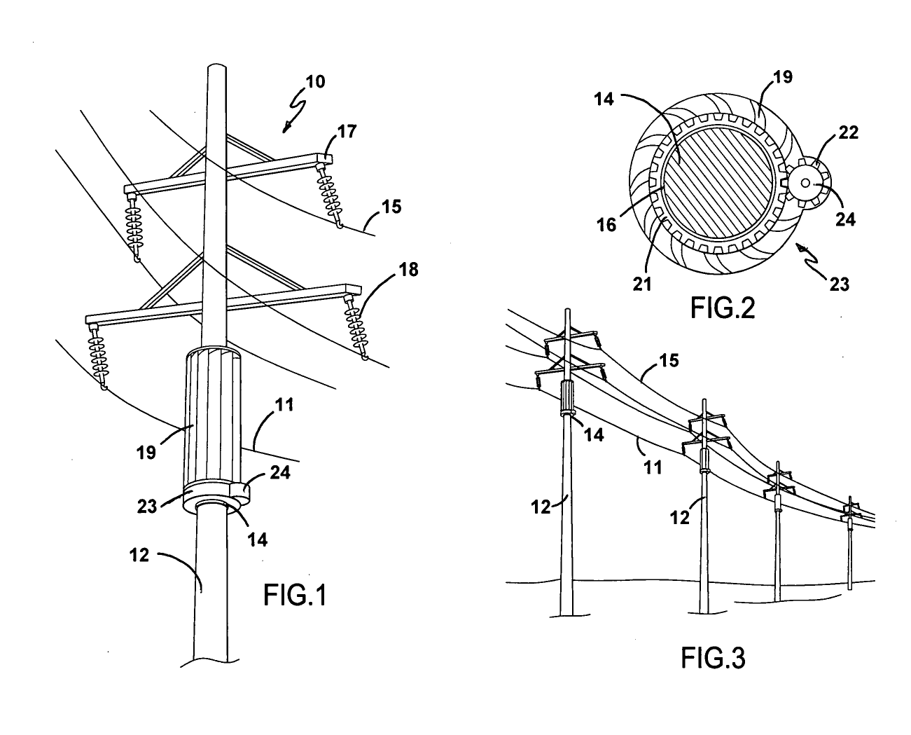

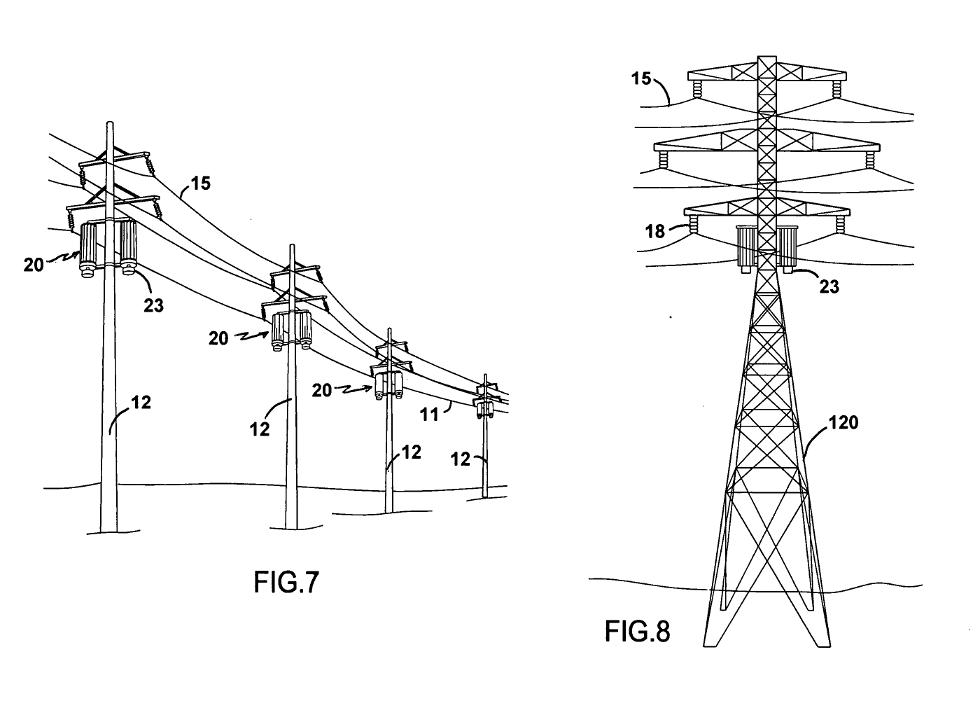

As shown in FIGS. 1, 3, 6, and 7, when used with power pole 12 utility systems, typically wooden poles 12 are used to support wire, cable and related equipment such as transformers and streetlights, such as electrical power lines 15 and communication lines 11. Traditionally, utility poles 12 are made from wood, steel, reinforced or prestressed concrete, or fiber reinforced composite materials, and may be formed as a solid or hollow member. The power poles 12 usually include two conductor supporting cross bar members 17, the lower of which is longer in span, for supporting different conductors. The power poles 12 are typically positioned within easements created for communications, railways, or roadways on a variety of terrains. The power poles 12 themselves are typically made of a single vertical support member which, in accordance with the present invention, provides the structural support member for use as the rotor shaft 14 for erecting the wind turbine 20 rotor assembly. The overall height of a typical tall power pole is a particular advantage, in use with the present invention, because both wind power and stack effect (for helical devices) will be increased with an increase in height. The power pole 12 structural support member may be cylindrical, or square, shaped members and may be either solid, semi-solid, or hollow in construction. In addition, one or more structural support members maybe attached in a substantially vertical orientation to an existing power pole 12 or tower 120 on conductor cross bars 17 or crossbars 13 constructed specifically for use as a structural support member for erecting the wind turbine 20 rotor assembly.

As above, the power poles 12 typically support “T” or “H” shaped conductor supporting cross bar members 17 for supporting conductors for carrying the electrical power lines 15. The system 10 includes a power pole 12 electricity system having a plurality of ground based power poles 12 electrically connected to the utility grid. At least one of the power poles 12 is configured to include at least one predetermined elongated substantially vertical rotor shaft portion 14. The rotor shaft portion 14 has an outer surface and a vertical axis of rotation.

Vertical axis turbines 20 rotate about the vertical axis of the power pole 12, which is oriented, more or less, perpendicular to the ground. The present invention contemplates the use of any type of vertical axis turbine 20 assembly well known in the art including such devices which are well known as the Darrieus type wind turbine, a Giromill-type Darrieus wind turbine, a Savonius wind turbine, a helix-style turbine, and the like. The wind turbine 20 is desirably deployed at any predetermined height which is most efficient when taking into consideration such factors as the existing dimensions of the rotor shaft portion 14, of the power pole 12, together with other variables which relate to the desired use, output potential, environmental impact, and terrain. The wind turbines 20 can be spatially oriented in arrays, as shown in FIGS. 3, 7, 10, 12, and 14, for any distributed wind energy system that conforms with the requirements of transmissions companies, electrical storage, output, safety and other municipal and governmental regulations.

The wind turbines 20 are rotatably connected to the rotor shaft portion 14 of the upright support member 12 by any conventional mechanical, or other suitable, methods such as clamping, bolting or welding. The vertical axis wind turbine 20 desirably includes two rotor assemblies, preferably including bearing assemblies 16 to rotatably mount to the rotor shaft portion 14 of the power pole 12. The rotor assemblies are affixed to the upright support member rotor shaft portions 14 either directly or indirectly, such as, when the wind turbine 20 includes upper and lower plates connecting the bearing assemblies 16 to the rotor shaft portion 14 of the power pole support member 12. As such, the rotor assembly may, but need not, include a circular bottom plate, a circular top plate, with the vanes 19 disposed circumferentially between the bottom and top plates. The rotor assembly rotates about the rotor shaft portion 14 when exposed to an atmospheric wind condition.

A power takeoff assembly 23, 230 is provided. It desirably includes a gear driven configuration with a drive gear 21 and one or more driven gears 22 depending on the number of generators 24 to be driven. The power takeoff assembly 23 may also be configured in a pulley or magnetic drive construction, of any type well known in the art. In the illustrated embodiments, shown in FIGS. 2 and 5, the drive gear 21 is rotatably engaged to the rotor assembly of the wind turbine 20 so that the rotor assembly and the drive gear 21 rotate as a single unit. The rotor assembly is supported on the rotor shaft portion 14 by an upper and lower bearing assemblies (located generally at 16). Bearing assemblies (not shown) including bearing balls and bearing races are included at 16 in order to allow the a rotor assembly to be rotatably mounted around the rotor shaft portion 14 and are of any design which is well known to one skilled in the art.

A plurality of wind vanes 19 are disposed in circumferential alignment about the rotor shaft 14 of the power pole 12. As shown in drawing figures a plurality of wind turbine 20 rotor assemblies may be mounted on a single power pole 12 on cross bars 17 to provide additional electrical power to the utility grid for each pole 12.

The generator 24 is of any type well known in the art which produces d-c potential, including generators and rotating electrical machines. More than one generator 24 may be deployed in engagement with the power take off 23, 230 from a single wind turbine 20 as, for example, where the power pole 12 is a digital transmission tower 30. The generator 24 is connected with output leads (not shown) either to the power pole 12 electricity system, the utility grid, or an energy storage system connected to the utility grid. As above, the overall construction of the generator 24, power takeoff 23, 230, and wind turbine 20 is dependant upon a variety of variables associated with the construction of electrical rotating machines according to standards within the industry.

With deployment, as illustrated in FIGS. 1, and 2, in its simplest embodiment, which is highly useful in a retrofit application, a power pole support 12 is provided which includes electricity lines 15 connected to the grid. The power pole 12 ground-based structural support members provide the desired location for at least one substantially vertical rotor shaft portion 14 having an outer surface and a vertical axis of rotation for attachment of the wind turbine 20, power takeoff 21, 22, and generator 24 assemblies. In a preferred embodiment, the wind turbine 20, power takeoff 23, 230, and generator 24 devices are designed, constructed, and shipped as a single functional unit for attachment, erected, and electrically connected, on-site, to the power pole support 12 at any desired predetermined position at the pole 12 rotor shaft 14 portion.

Mounting the vertical axis wind turbine 20 rotor assembly to the rotor shaft 14 portion of the power pole 12 may be made by attaching the bearing assemblies, at 16 directly to the rotor shaft portion 14, or with the use of upper and lower mounting brackets or plates which either house or connect to the bearing assemblies, in any such manner which is well known, so long as the wind turbine 20 rotor assembly rotates freely around the outer surface of the rotor shaft portion 14 when the vanes 19 are exposed to an atmospheric wind condition.

The power takeoff assembly 23, 230, the bearing assembly positioned at 16, and the generator 24 are preferably contained within a common housing configured to receive the assemblies in workable engagement with one another, and to protect the assembled configuration from harsh atmospheric conditions. The generator 24 is finally connected, via output leads, or in any other manner, to the utility grid via the electricity system or electrical storage devices. An inverter may, but need not, be electrically connected in order to change the current as needed.

In use, cross winds impinge upon the wind vanes of the rotor assembly to produce rotation of the rotor assembly, in relation to the rotor shaft 14 portion. The power takeoff 23, 230, concurrently engages the generator 24 which generates electricity to the power pole electricity system, electricity storage system, or both, which, in turn distribute energy directly to the utility grid.

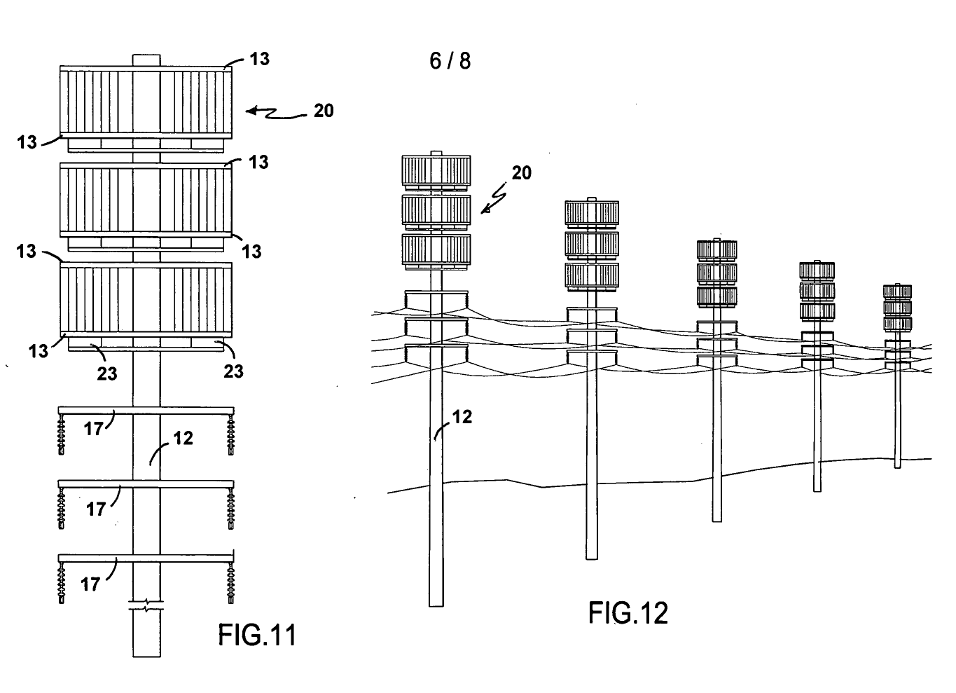

As shown in FIGS. 3, 7, 10, 12, and 14, the present invention is preferably deployed on a network of power poles 12 as an array of wind turbines 20. Moreover the power takeoff 23, 230 may be used to drive more than one generator 24 per wind turbine 20. Finally, and as specifically contemplated herein, the rotor shaft portion 14 may be an attachment to an existing power pole or tower structure so as to support more than one wind turbine 20 in lateral alignment, or in axial alignment as one on top of the other which is illustrated in FIGS. 11 and 12.

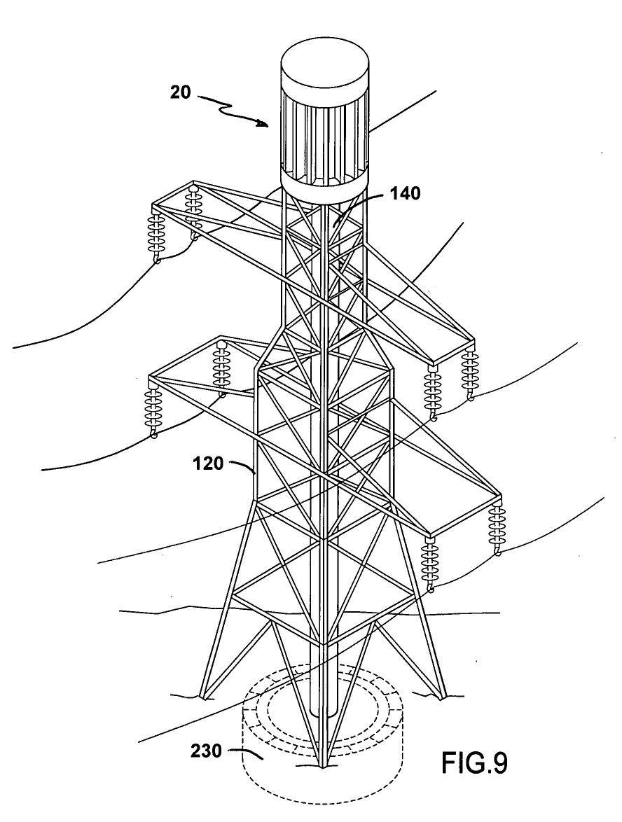

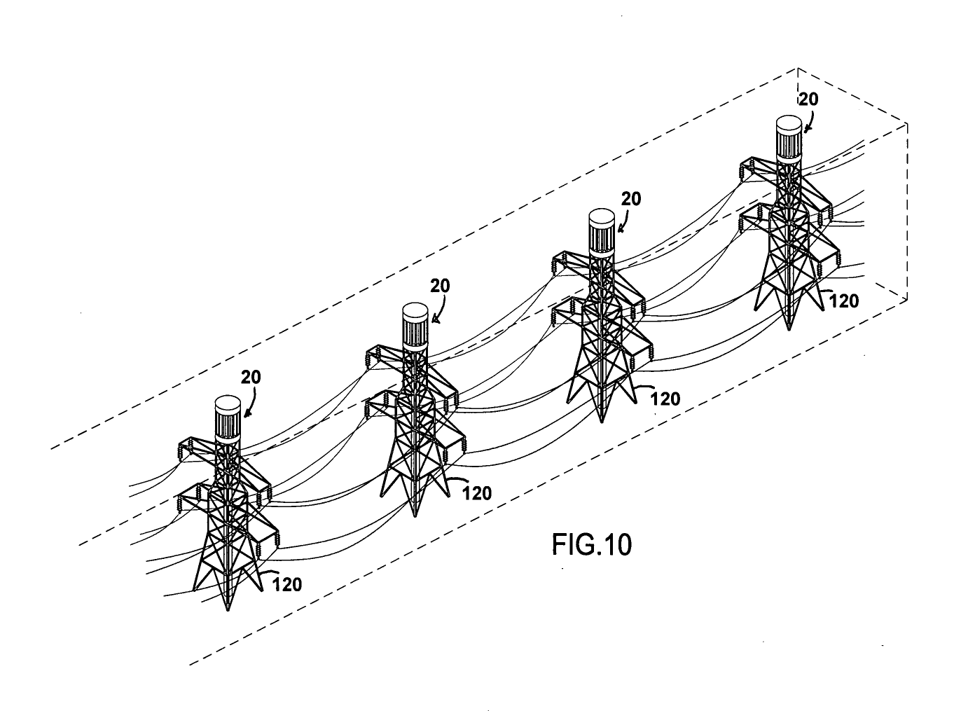

Turning now to FIGS. 9 and 10, an example of the present invention is shown as erected on a transmission tower 120, or pylori, and deployed in an array of the same. In this example, the transmission tower 120 includes an upper axially positioned tower mast which serves as the rotor shaft portion 140 for erecting the wind turbine 20, and the drive gear preferably engages one or more generators which may be positioned in a spaced arrangement about the driven gear, and housed in the power take off assembly 230. With this embodiment, the power take off assembly 230 is preferably constructed on or below ground, in order to protect it from adverse environmental conditions. The rotor shaft portion 140 may be one which was previously constructed or one which is retrofit as an assembly including the rotor shaft portion 140, wind turbine 20, power take off assembly 230. As shown in the drawing figures, the drive gear (not shown) and driven gears (not shown) are ground-based and are connected in axial alignment with the rotor shaft portion 140 for ease in servicing and stability, of the overall transmission tower 120 construction.

Referring now the FIGS. 11 and 12, the power pole 12 is configured to include six specially constructed cross bar members 13 which are attached to poles 12. In this example, the cross bar members 13 are preferably of an equal span. The rotor shaft portions (not shown) are erected vertically on cross bars 13 which are, pivotally or stationary, attached to the pole 12. Erected on the rotor shaft portions are six vertical axis wind turbines 20 so that the rotor assemblies rotate freely around the outer surface of the rotor shaft portions when exposed to an atmospheric wind condition. In this example, the power takeoff assemblies 23, together with the generators 24, are coupled to the wind turbine rotor 20 assemblies in axial alignment with the rotor shaft portions of the structural support members when supported on cross bars 13.

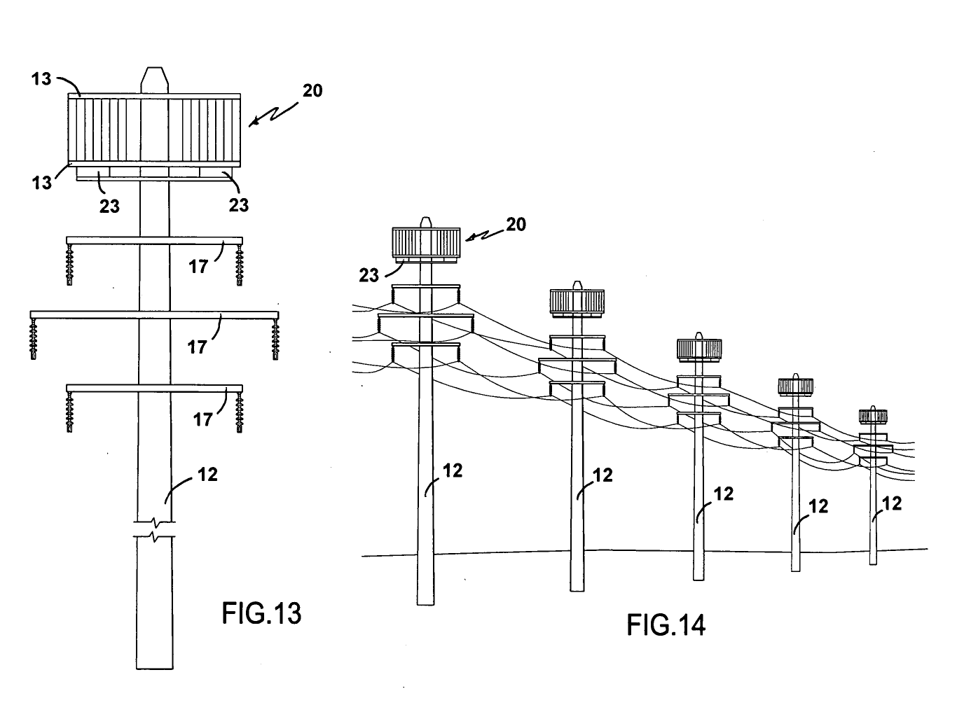

FIGS. 13 and 14 illustrate an embodiment of the present invention where two wind turbines 20 are deployed between four cross bar members 13 which are attached to poles 20, in a manner similar to that described above, and an array of the same.

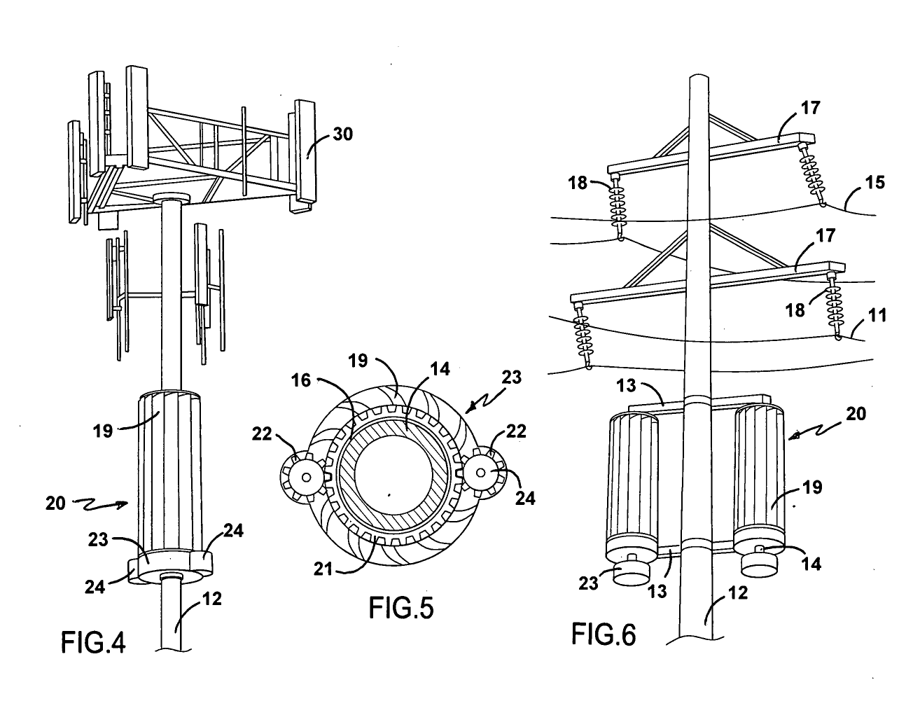

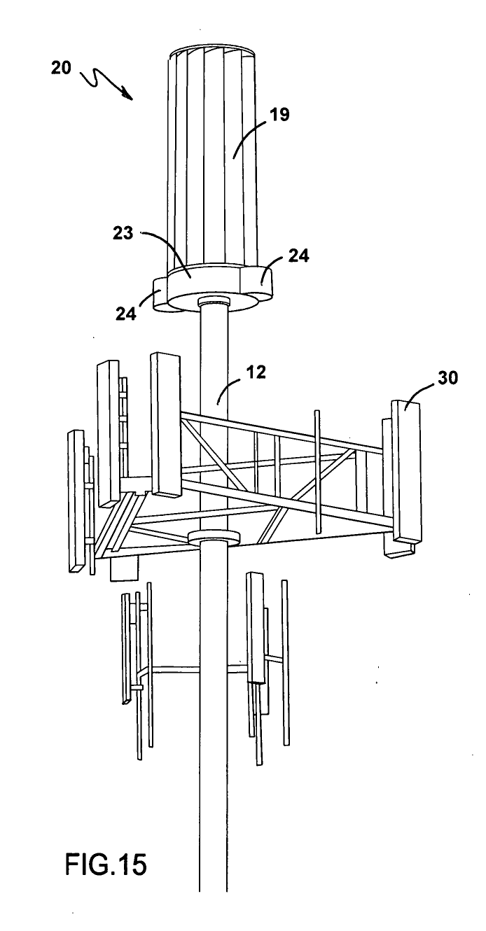

FIG. 15 illustrates an embodiment of the present invention, also shown in FIG. 4, where the wind turbine 20 is deployed on a digital signal transmission pole 12. In this embodiment, the present invention is desirably configured so that two generators 24 laterally engage the power take off 23.

While the present invention has been described in connection with the embodiments as described and illustrated above, it will be appreciated and understood by one of ordinary skill in the art that modifications may be made to the present invention without departing from the true spirit and scope of the invention, as broadly described and claimed herein.

I claim:

1-9. (canceled)

10. A vertical axis wind system for distributed wind energy generation to a utility grid, comprising:
(a) an overhead electricity structural support member for supporting an electricity conductor, electrically connected to the utility grid, having at least one rotor shaft portion including an outer surface and a vertical axis of rotation;
(b) at least one vertical axis wind turbine having a rotor assembly, including a plurality of wind vanes, erected on the rotor shaft portion so that the rotor assembly rotates freely around the outer surface of the rotor shaft portion when exposed to an atmospheric wind condition;
(c) a power takeoff assembly coupled to the wind turbine having a drive member and a driven member;
(d) a generator driven by the driven member; and
(e) a transmission line connected to the generator for electrification of the utility grid.

11. The vertical axis wind system for distributed wind energy generation according to claim 10, wherein the rotor shaft portion is a power or telephone pole.

12. The vertical axis wind system for distributed wind energy generation according to claim 10, wherein the rotor shaft portion is a tower mast member.

13. The vertical axis wind system for distributed wind energy generation according to claim 10, wherein the rotor shaft portion is an antenna.

14. The vertical axis wind system for distributed wind energy generation according to claim 10, wherein the drive and driven members include gears, magnets, or pulleys.

15. The vertical axis wind system for distributed wind energy generation according to claim 10, wherein the rotor assembly is rotatably connected to the rotor shaft portion with a bearing assembly.

16. The vertical axis wind system for distributed wind energy generation according to claim 10, wherein the support structure includes at least two cross bars supporting at least two rotor shaft portions for erecting at least two wind turbine rotor assemblies and wherein the generators are in axial alignment with the rotor shaft portions.

17. The vertical axis wind system for distributed wind energy generation according to claim 12, wherein the drive member is a ground-based gear rotatably connected in axial alignment with the rotor shaft portion.

18. In combination, with an overhead electricity structural support member for supporting an electricity conductor, electrically connected to the utility grid, having at least one rotor shaft, the rotor shaft portion having an outer surface and a vertical axis rotation, the improvement, comprising:
(a) at least one vertical axis wind turbine having a rotor assembly, including a plurality of wind vanes, erected on the rotor shaft portion so that the wind turbine rotor assembly rotates freely around the outer surface of the rotor shaft portion when exposed to an atmospheric wind condition;
(b) a power takeoff assembly coupled to the wind turbine having a drive member and a driven member;
(c) a generator driven by the driven member; and
(d) a transmission line connected to the generator for electrification of the utility grid.

19. The improvement according to claim 18, wherein the rotor shaft portion is a power or telephone pole.

20. The improvement according to claim 18, wherein the rotor shaft portion is a tower mast member.

21. The improvement according to claim 18, wherein the rotor shaft portion is an antenna.

22. The improvement according to claim 18, wherein the drive and driven members include gears, magnets, or pulleys.

23. The improvement according to claim 18, wherein the rotor assembly is rotatably connected to the rotor shaft portion with a bearing assembly.

24. The improvement according to claim 18, wherein the support structure includes at least two cross bars supporting at least two rotor shaft portions for erecting at least two wind turbine rotor assemblies and wherein the generators are in axial alignment with the rotor shaft portions.

25. The improvement according to claim 20, wherein the drive member is a ground-supported rotatably connected in axial alignment with the rotor shaft portion.

26. A method for distributed wind energy generation of electrical energy to a utility grid, comprising the steps of:
(a) providing an overhead electricity structural support member for supporting an electricity conductor, electrically connected to the utility grid, having at least one rotor shaft portion including an outer surface and a vertical axis of rotation;
(b) erecting at least one vertical axis wind turbine having a rotor assembly, including a plurality of wind vanes, on the rotor shaft portion so that the rotor assembly rotates freely around the outer surface of the rotor shaft portion when exposed to an atmospheric wind condition;
(c) coupling a power takeoff assembly to the wind turbine having a drive member and a driven member;
(d) driving a generator with the driven member;
(e) connecting a transmission line to the generator for electrification of the utility grid; and
(f) exposing the wind turbine to an atmospheric wind condition so that the rotor assembly rotates in relation to the rotor shaft portion so that the power takeoff drives the generator to produce electrical energy to the utility grid.

27. The method according to claim 26, wherein the rotor shaft portion is a power or telephone pole.

28. The method according to claim 26, wherein the rotor shaft portion is a tower mast member.

29. The method according to claim 26, wherein the rotor shaft portion is an antenna.

30. The method according to claim 26, wherein the drive and driven members include gears, magnets, or pulleys.

31. The method according to claim 26, wherein the rotor assembly is rotatably connected to the rotor shaft portion with a bearing assembly.

32. The method according to claim 26, wherein the support structure includes at least two cross bars supporting at least two rotor shaft portions for erecting at least two wind turbine rotor assemblies and wherein the generators are in axial alignment with the rotor shaft portions.

33. The method according to claim 28, wherein the drive member is a ground-based gear rotatably connected in axial alignment with the rotor shaft portion.
